(19) United States
(12) Patent Application Publication
(10) Pub. No.: US 2026/0106347 A1
(43) Pub. Date: Apr. 16, 2026

(54) INSPECTION UNIT AND INSPECTION DEVICE

(71) Applicant: OMRON Corporation, Kyoto-shi (JP)

(72) Inventors: Takahiro SAKAI, Kyoto-shi (JP); Riku YOSHIMOTO, Kyoto-shi (JP); Minori YAHAGI, Kyoto-shi (JP); Naoya SASANO, Kyoto-shi (JP); Hiroyuki HARIMOCHI, Kyoto-shi (JP)

(21) Appl. No.: 19/350,868

(22) Filed: Oct. 6, 2025

(30) Foreign Application Priority Data
Oct. 16, 2024 (JP) 2024-180942

(51) Int. Cl. H01M 50/569; H01M 10/42; H01R 13/24; H01R 13/631

(52) U.S. Cl. CPC H01M 50/569; H01M 10/4285; H01R 13/2421; H01R 13/2492; H01R 13/6315

(57) ABSTRACT

To provide an inspection unit capable of improving contact reliability between an electrode terminal of a battery and a probe pin. An inspection unit according to the present disclosure contacts an electrode terminal of a battery to inspect its performance. The unit comprises a plurality of probe pins, a socket housing the plurality of probe pins to be movable by a first distance in an axial direction, and a housing housing the socket to be movable by a second distance in the axial direction. The unit further includes a biasing member disposed inside the housing that biases the socket so a part of the socket protrudes from an opening in the housing, and elastic portions disposed inside the socket that elastically deform to move each probe pin independently in the axial direction.

### CROSS REFERENCE TO RELATED APPLICATIONS

The present invention claims priority under 35 U.S.C. § 119 to Japanese Patent Application No. 2024-180942, filed on Oct. 16, 2024, the entire content of which is incorporated herein by reference in its entirety.

### BACKGROUND

The present disclosure relates to an inspection unit that comes into contact with an electrode terminal of a battery to inspect performance of the battery, and an inspection device including the inspection unit.

In recent years, prismatic secondary batteries capable of coping with high current (for example, 80 amperes or more), such as batteries for an electric vehicle (hereinafter, referred to as EV), have been increasing. Therefore, an inspection unit capable of coping with a high current is required also in the inspection unit.

Conventionally, as this type of inspection unit, for example, an inspection unit described in JP 2018-124252 A is known. JP 2018-124252 A discloses a technique capable of easily assembling a probe pin even when the probe pin includes a plurality of members.

### SUMMARY

In the conventional inspection unit, from a viewpoint of improving contact reliability between an electrode terminal of a battery and a probe pin, there is still room for improvement.

Therefore, one non-limiting and exemplary embodiment provides an inspection unit and an inspection device capable of improving contact reliability between an electrode terminal of a battery and a probe pin.

An inspection unit according to an aspect of the present disclosure is an inspection unit that comes into contact with an electrode terminal of a battery to inspect performance of the battery, the inspection unit including:
a plurality of probe pins;
a socket that houses the plurality of probe pins to be movable by a first distance in an axial direction;
a housing that houses the socket to be movable by a second distance in the axial direction;
a biasing member that is disposed inside the housing and biases the socket in the axial direction such that a part of the socket protrudes outside from an opening provided in the housing; and
elastic portions that are disposed inside the socket and each elastically deform so as to move one of the probes pins independently in the axial direction.

An inspection device according to an aspect of the present disclosure includes a plurality of the inspection units according to the above aspect.

According to the present disclosure, it is possible to provide an inspection unit and an inspection device capable of improving contact reliability between an electrode terminal of a battery and a probe pin. Additional benefits and advantages of the disclosed embodiments will be apparent from specification and Figures. The benefits and/or advantages may be individually provided by the various embodiments and features of the specification and drawings, disclosure, and need not all be provided in order to obtain one or more of the same.

### BRIEF DESCRIPTION OF DRAWINGS

These and other objects and features of the present disclosure will become clear from the following description taken in conjunction with the preferred embodiments thereof with reference to the accompanying drawing, in which:

FIG. 1 is a perspective view of an inspection unit according to an embodiment of the present disclosure as viewed obliquely from above;

FIG. 2 is a perspective view of the inspection unit of FIG. 1 as viewed obliquely from below;

FIG. 3 is an exploded perspective view of the inspection unit of FIG. 1;

FIG. 4 is a perspective view illustrating a configuration in which some components of the inspection unit of FIG. 1 are removed;

FIG. 5 is a plan view illustrating a configuration of FIG. 4, and is a view illustrating a state in which tip portions of probe pins are located at a protruded position;

FIG. 6 is a plan view illustrating the configuration of FIG. 4, and is a view illustrating a state in which the tip portions of the probe pins are located at a housed position;

FIG. 7 is an exploded perspective view illustrating the configuration of FIG. 4;

FIG. 8 is an enlarged perspective view illustrating the configuration of FIG. 4 in a partially cross-sectional manner;

FIG. 9 is a side view illustrating a state in which the tip portions of the plurality of probe pins included in the inspection unit of FIG. 1 are in contact with an electrode terminal of a battery;

FIG. 10 is a perspective view illustrating an example of an inspection device including the inspection units according to the present embodiment;

FIG. 11 is a perspective view illustrating a variation of the inspection unit of FIG. 1, in which some components are removed;

FIG. 12 is an exploded perspective view illustrating a variation of the plurality of probe pins;

FIG. 13 is an enlarged perspective view of FIG. 12; and

FIG. 14 is a plan view illustrating a variation of the plurality of probe pins in a partially transparent manner.

### DETAILED DESCRIPTION

### Knowledge Underlying the Present Disclosure

The present inventors have extensively conducted studies for providing an inspection unit capable of improving contact reliability between an electrode terminal of a battery and a probe pin, and as a result, the present inventors have obtained the following knowledge.

A probe pin of a conventional inspection unit is formed with a plurality of contact portions having pointed tips. In the conventional inspection unit, the probe pin is biased by a coil spring so that the plurality of contact portions are kept in contact with an electrode terminal of a battery. In the conventional inspection unit, the number of contact portions is increased (for example, several hundred) to improve contact reliability between the electrode terminal and the probe pin.

However, the electrode terminal of the battery is not always flat, and may have a step portion or unevenness. Therefore, even when a large number of contact portions are provided on the probe pin, the contact portions actually in contact with the electrode terminal are extremely few (for example, three points). A current flows only in portions where the contact portions and the electrode terminal are in contact with each other; therefore, when the number of contact portions in contact with the electrode terminal is small, an arc may be generated, and the tip of the contact portion may be melted.

To address this issue, the present inventors conducted intensive studies, and as a result, the inventors have found a configuration including elastic portions that elastically deform such that a plurality of probe pins are allowed to move independently in an axial direction. According to this configuration, the plurality of probe pins can move so as to follow the step portion and the unevenness of the electrode terminal, and the contact reliability between the electrode terminal and the probe pin can be improved. Based on this novel knowledge, the present inventors have reached the following invention.

Hereinafter, an embodiment of the present disclosure will be described with reference to the accompanying drawings. The following description is merely an example in nature and is not intended to limit the present disclosure, an application of the present disclosure, or use of the present disclosure. The drawings are schematically drawn, and the ratios of dimensions and the like do not necessarily agree with the actual ones.

In the following description, for convenience of description, terms indicating directions such as “upper” and “lower” are used assuming a state in normal use. However, these terms do not mean to limit a use state or the like of the inspection unit and the inspection device of the present disclosure.

### Embodiment

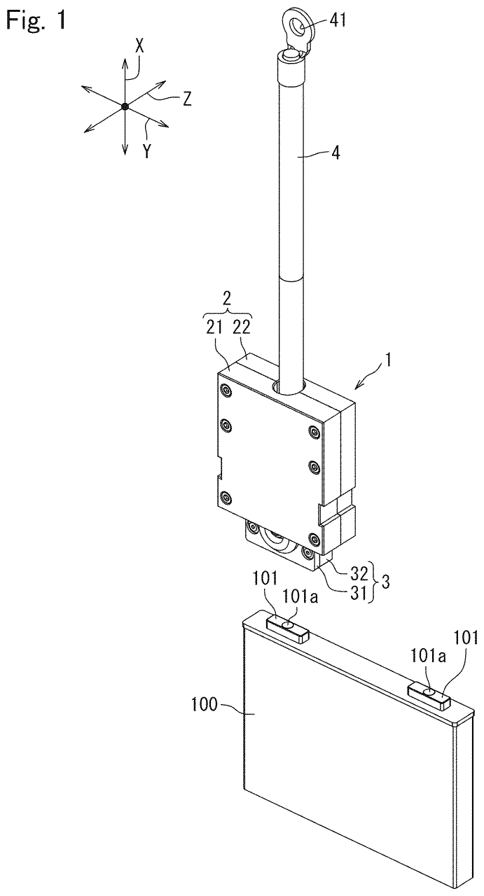

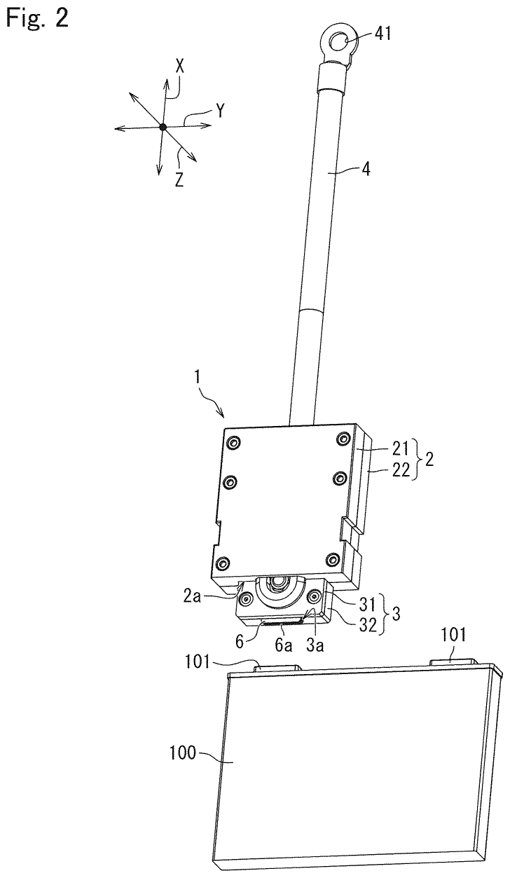

There will be described a configuration of an inspection unit according to an embodiment of the present disclosure. FIG. 1 is a perspective view of the inspection unit according to the embodiment of the present disclosure as viewed obliquely from above. FIG. 2 is a perspective view of the inspection unit of FIG. 1 as viewed obliquely from below.

As illustrated in FIG. 1 and FIG. 2, an inspection unit 1 according to the present embodiment is an inspection unit that comes into contact with an electrode terminal 101 of a battery 100 to inspect performance of the battery 100. In the present embodiment, the battery 100 is a prismatic secondary battery. For example, the battery 100 is a lithium-ion battery for an EV. The battery 100 has a size of, for example, 120 mm in height, 85 mm in width, and 12.5 mm in thickness. The inspection unit 1 is configured to perform, for example, charge and discharge inspection, energization inspection, and voltage inspection.

The battery 100 includes two electrode terminals 101. One electrode terminal 101 is a positive electrode terminal. The other electrode terminal 101 is a negative electrode terminal. In the present embodiment, the inspection unit 1 is configured to be in contact with any one of the two electrode terminals 101. A stepped portion 101a is formed in each of the two electrode terminals 101.

The inspection unit 1 includes a housing 2, a socket 3, and a cable 4.

The housing 2 has a substantially rectangular parallelepiped shape, and includes a housing cover 21 and a housing base 22. The housing cover 21 and the housing base 22 are combined, so that a housing space for housing the socket 3 and the cable 4 is formed inside the housing 2.

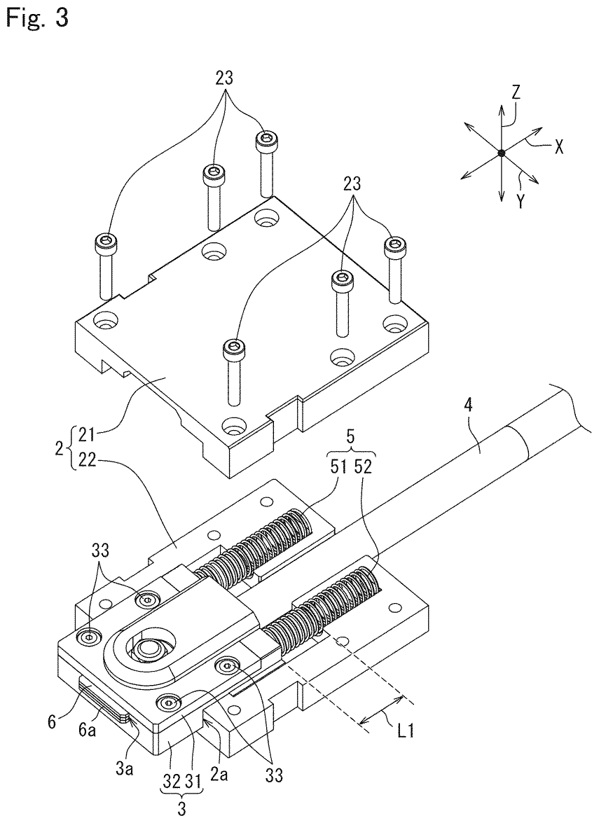

FIG. 3 is an exploded perspective view of the inspection unit 1.

As illustrated in FIG. 3, the housing cover 21 and the housing base 22 are fixed with a plurality of fastening members 23 such as screws. The housing 2 is configured to house the socket 3 to be movable by a distance L1 (second distance) in an axial direction X. The distance L1 is, for example, 15 mm. The housing 2 is formed such that a length in a width direction Y orthogonal to the axial direction X is longer than a length in a thickness direction Z orthogonal to the axial direction X and the width direction Y.

The socket 3 has a substantially rectangular parallelepiped shape, and includes a socket cover 31 and a socket base 32. The socket cover 31 and the socket base 32 are combined, so that a housing space for housing one end portion of the cable 4 is formed inside the socket 3. The socket cover 31 and the socket base 32 are fixed to each other with a plurality of fastening members 33 such as screws. Similarly to the housing 2, the socket 3 is formed such that a length in the width direction Y is longer than a length in the thickness direction Z.

The cable 4 is configured to extend in the axial direction X. The one end portion of the cable 4 is held inside the socket 3. The socket 3 and the cable 4 are configured to be integrally relatively movable with respect to the housing 2.

As illustrated in FIG. 1 and FIG. 2, a round terminal 41 for electrically connecting the cable 4 to an external device is connected to the other end portion of the cable 4. In the present embodiment, the cable 4 is a cable having a cross-sectional area (for example, 22 SQ) through which a high current (for example, 80 amperes or more) can flow.

As illustrated in FIG. 3, a biasing member 5 that biases the socket 3 in the axial direction X is disposed inside the housing 2 so that a part of the socket 3 protrudes outside from an opening 2a provided in the housing 2.

The biasing member 5 includes: a first spring member 51 that biases the one end portion side of the socket 3 in the width direction Y; and a second spring member 52 that biases the other end portion side of the socket 3 in the width direction Y. In the present embodiment, the first spring member 51 and the second spring member 52 are each configured with a coil spring. Biasing forces (spring constants) of the first spring member and the second spring member 52 are equal to each other.

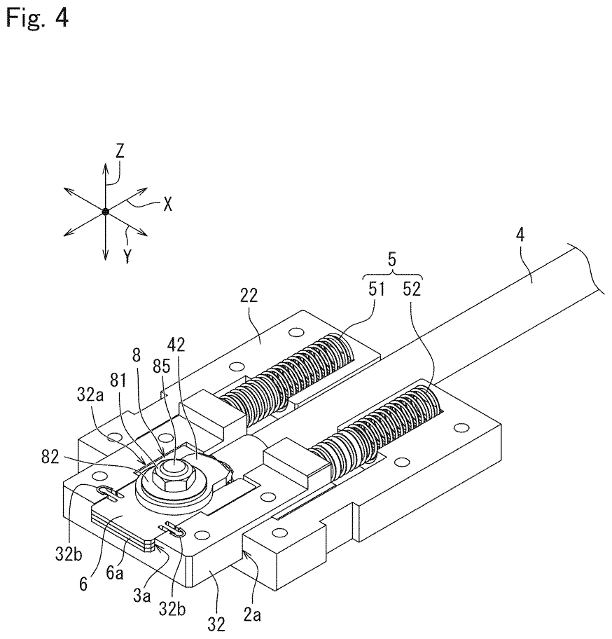

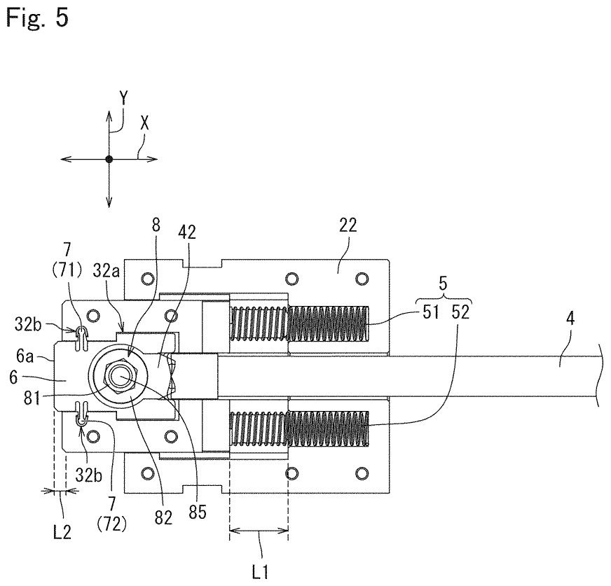

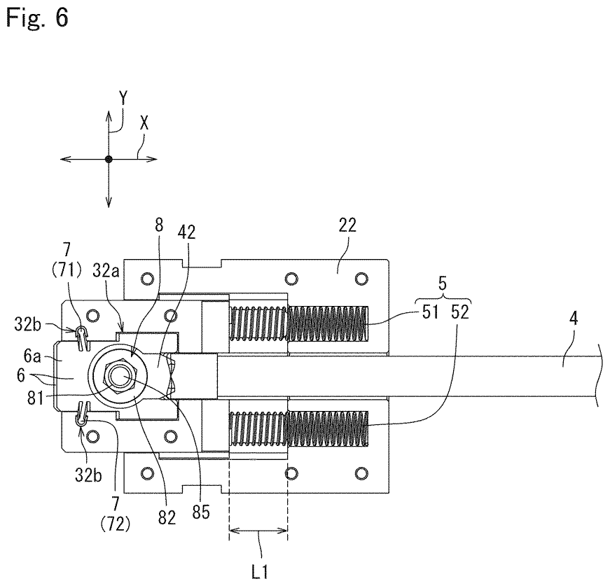

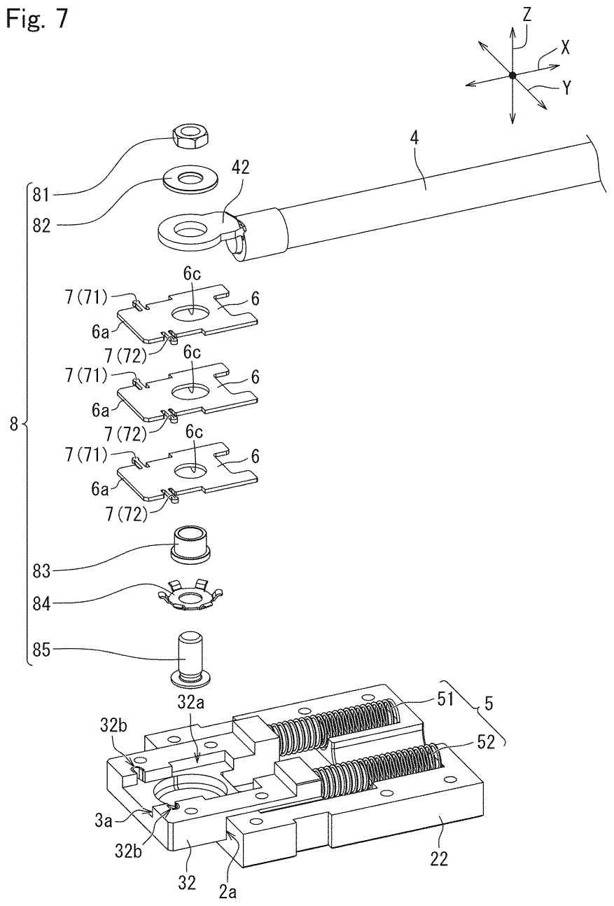

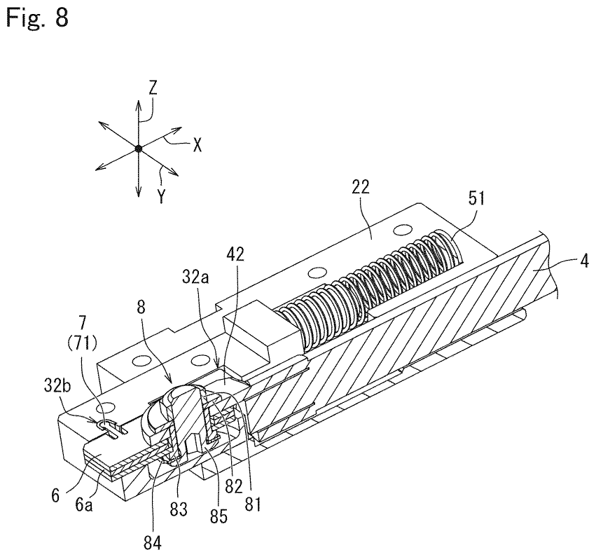

FIG. 4 is a perspective view illustrating a configuration in which the housing cover 21 and the socket cover 31, which are some components of the inspection unit 1, are removed. FIG. 5 is a plan view illustrating the configuration of FIG. 4 and is a view illustrating a state in which tip portions 6a of probe pins 6 are located at a protruded position. FIG. 6 is a plan view illustrating the configuration of FIG. 4 and is a view illustrating a state in which the tip portions 6a of the probe pins 6 are located at a housed position. FIG. 7 is an exploded perspective view illustrating the configuration of FIG. 4. FIG. 8 is an enlarged perspective view illustrating the configuration of FIG. 4 in a partially cross-sectional manner.

The socket 3 is configured to house the plurality of probe pins 6 to be movable by a distance L2 (first distance, see FIG. 5) in the axial direction X. The distance L2 is, for example, 1 mm.

In the present embodiment, as illustrated in FIG. 4 to FIG. 8, the socket base 32 is provided with a recess 32a that houses three plate-shaped probe pins 6 such that the three plate-shaped probe pins 6 are stacked on each other in the thickness direction Z. Each of the probe pins 6 is configured to be movable by the distance L2 in the axial direction X in the recess 32a. Each of the probe pins 6 has a thickness of, for example, 1 mm.

Inside the socket 3, there are disposed elastic portions 7 that allow each of the probe pins 6 to move independently in the axial direction X. The elastic portions 7 are in an elastically non-deformed state when the tip portion 6a of each of the probe pins 6 is located at the protruded position (see FIG. 5) protruded outside from the opening 3a provided in the socket 3. In addition, the elastic portions 7 are configured to be elastically deformed when the tip portion 6a of each of the probe pins 6 moves to the housed position (see FIG. 6) located inside the socket 3.

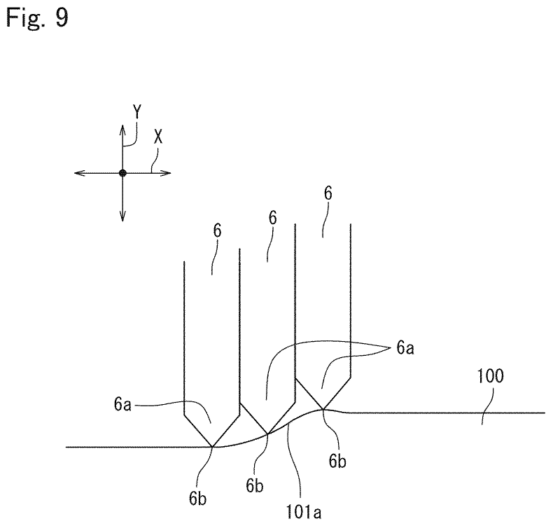

As illustrated in FIG. 9, a contact portion 6b whose tip is sharp is formed on the tip portion 6a of each of the probe pins 6. Since each of the probe pins 6 is independently moved in the axial direction X, each of the contact portions 6b can move along a stepped portion 101a of the electrode terminal 101 of the battery 100. In the present embodiment, a plurality of the contact portions 6b are formed at intervals in a longitudinal direction (width direction Y) on the tip portion 6a of each of the probe pins 6.

In the present embodiment, the elastic portion 7 has elastic arm portions 71 and 72 protruding in the width direction Y from both side portions of each of the probe pins 6. The elastic arm portions 71 and 72 are disposed in U-shaped recesses 32b provided in the socket base 32, and are configured to be elastically deformable in the axial direction X in the recesses 32b. When the probe pins 6 are located at the housed position (see FIG. 6), the probe pins 6 are in contact with a side wall of the recess 32a and are restricted from moving in the axial direction X against a biasing force of the biasing member 5. As a result, the load applied to the elastic arm portions 71 and 72 can be reduced, and excessive elastic deformation of the elastic arm portions 71 and 72 can be suppressed. In the present embodiment, the elastic arm portions 71 and 72 are configured integrally with the probe pin 6.

An elastic force of the elastic portions 7 is set to be smaller than the biasing force of the biasing member 5. That is, when a load is applied to the inspection unit 1 in the axial direction X, the elastic portions 7 are elastically deformed by the distance L2 before the biasing member 5 is compressed by the distance L1. The biasing force of the biasing member 5 is set to be equal to or larger than, for example, 15 times the elastic force of the elastic portions 7.

The probe pins 6 are stacked in the thickness direction Z and sandwiched by a sandwiching member 8 that is elastic in the thickness direction Z. Thus, the probe pins 6 are in close contact with each other in the thickness direction Z. Conductive grease or conductive gel is applied between the probe pins 6 and 6 adjacent to each other. As a result, each probe 6 can smoothly move independently in the axial direction X.

As illustrated in FIG. 7, each of the probe pins 6 has an elongated hole 6c that penetrates in the thickness direction Z and is longer in the axial direction X. In the present embodiment, the elongated holes 6c have an elliptical shape. The elongated holes 6c may be rectangular. The sandwiching member 8 includes a nut 81, a ring-shaped spacer 82, a cylindrical spacer 83 having a flange, a spring washer 84, which is an example of an elastic member having elasticity in the thickness direction Z, and a bolt 85 which is an example of a pin. A round terminal 42 is connected to one end portion of the cable 4.

The nut 81 is disposed on the probe pin 6 disposed on one side (upper side in FIG. 8) in the thickness direction Z, via the spacer 82 and the round terminal 42 of the cable 4. The bolt 85 is inserted into the elongated hole 6c of each of the probe pins 6 from the other side (lower side in FIG. 8) in the thickness direction Z via the spring washer 84 and the spacer 83, and is screwed to the nut 81. As a result, the probe pins 6 are sandwiched in a state of being in close contact with each other in the thickness direction Z by an elastic force of the spring washer 84. In addition, the cable 4 is electrically in contact with the probe pin 6 disposed on one side (upper side in FIG. 8) in the thickness direction Z, via the round terminal 42.

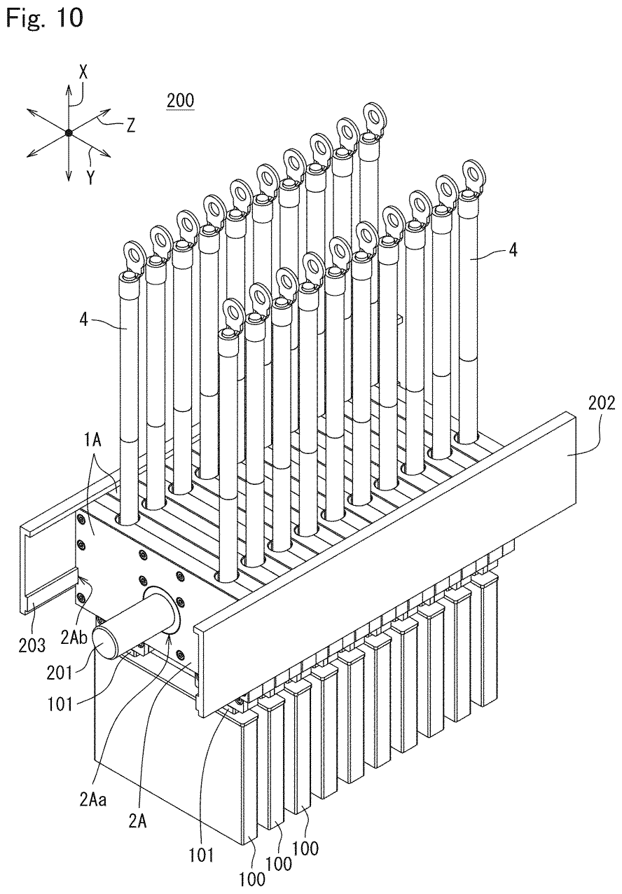

FIG. 10 is a perspective view illustrating an example of an inspection device 200 including the inspection units 1 according to the present embodiment.

The inspection device 200 includes a plurality of the inspection units 1, and is configured to be able to simultaneously inspect performance of a plurality of batteries 100. In FIG. 10, the inspection device 200 includes inspection units 1A each having a housing 2A in which two inspection units 1 are arranged adjacent to each other and in which the housings 2 of the respective inspection units 1 are integrated. The inspection device 200 includes the plurality of inspection units 1A in parallel in the thickness direction Z. The housings 2A each have a size of, for example, 57 mm in height, 125 mm in width, and 13.5 mm in thickness.

Through-holes 2Aa penetrating in the thickness direction Z are provided at central portions in the axial direction X and the width direction Y of the housings 2A. A cylindrical shaft 201 is inserted in the through-hole 2Aa of each of the inspection units 1A. In each of the inspection units 1A, both side portions in the width direction Y are held by a pair of side plates 202 and 202. Groove portions 2Ab extending in the thickness direction Z are provided on two side surfaces facing each other in the width direction Y of the housing 2A of each of the inspection unit 1A. Each of the side plates 202 and 202 is provided with a rail 203 that extends in the thickness direction Z and is inserted into one of the groove portions 2Ab. As a result, the plurality of inspection units 1A are held at predetermined intervals in the thickness direction Z.

Next, a description will be given on an example of an operation of inspecting the performance of the plurality of batteries 100 using the inspection device 200.

First, as illustrated in FIG. 10, the inspection device 200 is disposed at a position facing the electrode terminals 101 and 101 of the respective batteries 100.

Thereafter, the inspection units 1A are moved in the axial direction X (downward in the drawing), and the contact portion 6b of each of the probe pins 6 is brought into contact with the electrode terminal 101 or 101 of the corresponding battery 100. As a result, the elastic portion 7 of each of the probe pins 6 is elastically deformed, and the tip portion 6a of each of the probe pins 6 moves from the protruded position (see FIG. 5) to the housed position (see FIG. 6). At this time, each of the probe pins 6 moves independently in the axial direction X, and each of the contact portions 6b moves along the stepped portion 101a of the electrode terminal 101 as illustrated in FIG. 9.

Thereafter, the biasing member 5 of each of the inspection units 1A is compressed in the axial direction X. At this time, even when the positions of the plurality of batteries 100 in the axial direction X are different by a distance equal to the distance L1 or less, the respective biasing members 5 become to have compressed lengths corresponding to the differences, so that the contact portions 6b of all the inspection units 1A come into contact with the electrode terminals 101 of the corresponding batteries 100. In this state, the inspection device 200 performs various inspections on the plurality of batteries 100.

According to the inspection units 1 and 1A according to the present embodiment, there are included the elastic portions 7 each of which elastically deforms so as to move the plurality of probe pins 6 independently in the axial direction X. With this configuration, the plurality of probe pins 6 can move so as to follow the stepped portion 101a of the electrode terminal 101. As a result, the number of the contact portions 6b in contact with the electrode terminal 101 can be increased, and the contact reliability between the electrode terminal 101 and the probe pins 6 can be improved. In addition, arc can be suppressed from occurring, and durability of the probe pins 6 can be improved.

Furthermore, according to the inspection units 1 and 1A according to the present embodiment, the distance L2 is set to be shorter than the distance L1. This configuration can reduce the load applied to the elastic portion 7, and the elastic portion 7 can have a simple structure like the elastic arm portions 71 and 72.

According to the inspection units 1 and 1A according to the present embodiment, the elastic force of the elastic portions 7 is set to be smaller than the biasing force of the biasing member 5. With this configuration, the elastic portions 7 can have a simpler structure like the elastic arm portions 71 and 72 as compared with the biasing member 5.

Furthermore, according to the inspection units 1 and 1A according to the present embodiment, the elastic portions 7 are configured as follows. When the tip portion 6a of each of the probe pins 6 is located at the protruded position, the elastic portions 7 are in the elastically non-deformed state, and when the tip portion 6a of each of the probe pins 6 moves to the housed position, the elastic portions 7 elastically deform. With this configuration, in a state where the tip portion 6a of each of the probe pins 6 is not in contact with the electrode terminal 101, a load can be prevented from being applied to the elastic portions 7, and the elastic portions 7 can have a simple structure like the elastic arm portions 71 and 72. In addition, when the tip portion 6a of each of the probe pins 6 moves to the housed position, the elastic portions 7 are elastically deformed, so that contact reliability between the probe pins 6 and the electrode terminal 101 can be improved.

Furthermore, according to the inspection units 1 and 1A according to the present embodiment, the probe pins 6 are each a plate-shaped probe pin, and are laminated in the thickness direction; and the elastic portions 7 each have the elastic arm portions 71 and 72 protruding in the width direction Y from both side portions of each of the probe pins 6. With this configuration, the elastic portion 7 and each of the probe pins 6 can be integrally configured, and the number of components can be reduced.

Furthermore, according to the inspection units 1 and 1A according to the present embodiment, the probe pins 6 are each a plate-shaped probe pin, are stacked in the thickness direction Z, and are sandwiched by the sandwiching member 8 having elasticity in the thickness direction Z. With this configuration, the probe pins 6 can be in contact with the electrode terminal 101 while being in close contact with each other in the thickness direction Z.

Further, according to the inspection units 1 and 1A according to the present embodiment, each of the probe pins 6 has the elongated hole 6c penetrating in the thickness direction Z and elongated in the axial direction X, and the sandwiching member 8 includes the bolt 85 inserted into the elongated holes 6c. With this configuration, the sandwiching member 8 can sandwich the plurality of probe pins 6 with a compact configuration.

According to the inspection units 1 and 1A according to the present embodiment, the biasing member 5 includes: the first spring member 51 that biases the one end portion side of each of the probe pins 6 in the width direction Y; and the second spring member 52 that biases the other end portion side of each of the probe pins 6 in the width direction Y. With this configuration, even when the electrode terminal 101 has an inclination or a step in the width direction Y, contact reliability in the width direction Y between each of the probe pins 6 and the electrode terminal 101 can be improved.

The inspection device 200 according to the present embodiment includes a plurality of inspection units 1A. With this configuration, a plurality of batteries 100 can be simultaneously inspected, and a total inspection time can be shortened.

Note that the present disclosure is not limited to the above embodiment, and can be practiced in various other aspects. For example, in the above description, the housing 2 has a closed structure except for the opening 2a and the hole through which the cable 4 is inserted, but the present disclosure is not limited thereto. The housing 2 may be provided with, for example, a slit or a hole for cooling the internal space.

In the above description, the inspection unit 1 includes the cable 4, but the present disclosure is not limited thereto. The inspection unit 1 may include, instead of the cable 4, a member capable of transmitting a current that flows through the probe pin 6, to an external device. For example, the inspection unit 1 may include a conductor including a metal rod and a connector fitted to the rod.

In the above description, the socket 3 is configured to house the three plate-shaped probe pins 6, but the present disclosure is not limited thereto. For example, the socket 3 may be configured to house two or four or more plate-shaped probe pins 6.

In the above description, each of the probe pins 6 has an elongated hole 6c, but the present disclosure is not limited thereto. For example, one of the plurality of probe pins 6 may have a round hole corresponding to the diameter of the cylindrical spacer 83 or the bolt 85. In this case, the movement of the probe pin 6 having the round hole is restricted from moving in the axial direction X, but the contact reliability between the electrode terminal 101 and the probe pin 6 can be improved since the other probe pins 6 having an elongated hole move in the axial direction X.

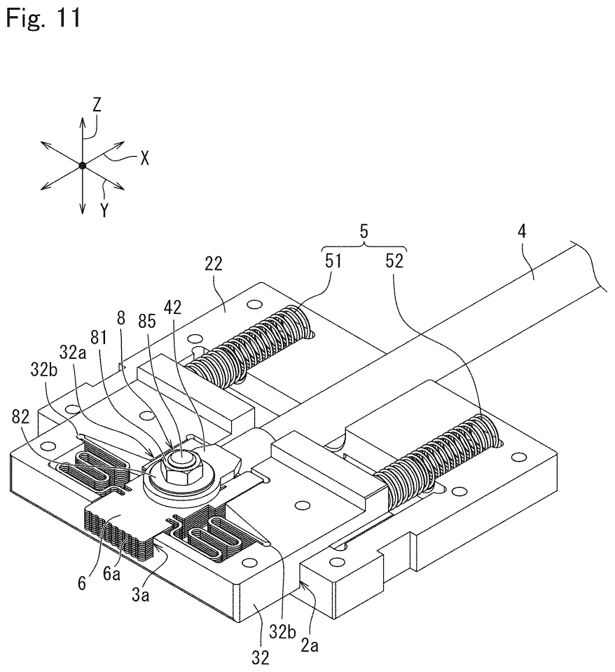

In the above description, the elastic arm portions 71 and 72 of the elastic portion 7 are illustrated to linearly protrude in the width direction Y from both side portions of each of the probe pins 6 (see, for example, FIG. 5), but the present disclosure is not limited thereto. The elastic arm portions 71 and 72 may be disposed in the U-shaped recesses 32b provided in the socket base 32 and be configured to be elastically deformable in the axial direction X in the recesses 32b. For example, as illustrated in FIG. 11, the elastic arm portions 71 and 72 may be formed in a meander shape.

In the above description, the tip portion 6a of each of the probe pins 6 is illustrated to be substantially flat (see, for example, FIG. 4 to FIG. 8), but the present invention is not limited thereto. The tip portion of each of the probe pins 6 may have a wave shape as illustrated in FIG. 11.

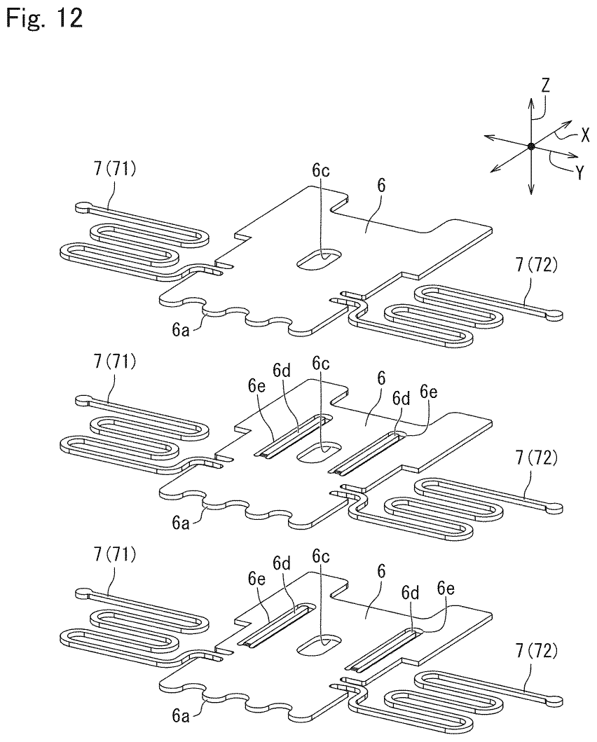

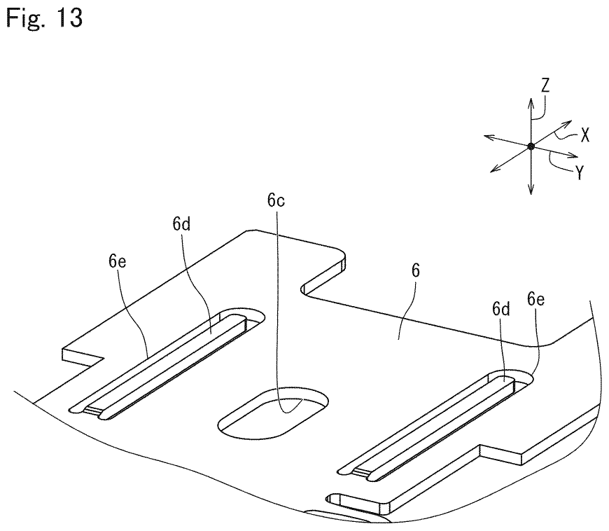

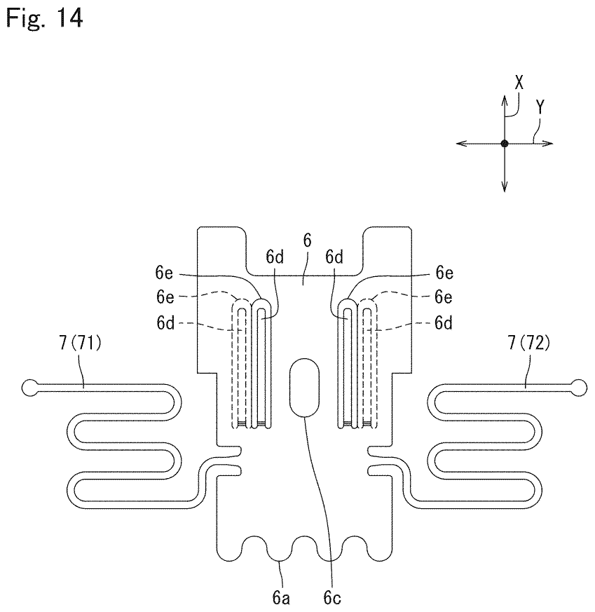

In the above description, all the probe pins 6 are illustrated to be flat plate-shaped members (see FIG. 7), but the present disclosure is not limited thereto. As illustrated in FIG. 12, one of the probe pins 6 adjacent to each other may be provided with elastic pieces 6d that bias the other of the probe pins 6 adjacent to each other in the thickness direction Z. As illustrated in FIG. 12, the elastic pieces 6d are portions each surrounded by a U-shaped through-hole 6e provided in a part of the probe pin 6. As illustrated in FIG. 13, the elastic pieces 6d are formed to be bent so as to protrude in the thickness direction Z and extend in the X direction beyond a main surface (XY plane) of the probe pin 6. The two elastic pieces 6d are provided at symmetrical positions with respect to the axial direction X in one probe pin 6. In addition, when the elastic pieces 6d are provided on both of the probe pins 6 adjacent to each other, the elastic pieces 6d are provided at positions that do not overlap each other in the thickness direction as illustrated in FIG. 14. According to the structure illustrated in FIG. 12 to FIG. 14, in a state where the probe pins 6 adjacent to each other are more reliably in contact with each other, a current can flow therebetween.

In the above description, the inspection device 200 includes the inspection units 1A each having the housing 2A in which the two inspection units 1 are disposed adjacent to each other and the housings 2 are integrated, but the present disclosure is not limited thereto. The inspection device 200 may separately include a plurality of the inspection units 1. As a result, for example, even for the battery 100 in which the distance between the two electrode terminals 101 is different, the inspection can be performed using the same inspection unit 1, and versatility can be improved.

Various embodiments of the present disclosure have been described above in detail with reference to the drawings. Finally, various aspects of the present disclosure will be described. In the following description, reference signs are also added as an example.

According to a first aspect of the present disclosure, there is provided an inspection unit 1 that comes into contact with an electrode terminal 101 of a battery 100 to inspect performance of the battery 100, and the inspection unit 1 including:
a plurality of probe pins 6;
a socket 3 that houses the plurality of probe pins 6 to be movable by a first distance L2 in an axial direction X;
a housing 2 that houses the socket 3 to be movable by a second distance L1 in the axial direction X;
a biasing member 5 that is disposed inside the housing 2 and biases the socket 3 in the axial direction X such that a part of the socket 3 protrudes outside from an opening 2a provided in the housing 2; and
elastic portions 7 that are disposed inside the socket 3 and each elastically deform so as to move one of the probe pins 6 independently in the axial direction X.

According to a second aspect of the present disclosure, there is provided the inspection unit 1 according to the first aspect, in which the first distance L2 is shorter than the second distance L1.

According to a third aspect of the present disclosure, there is provided the inspection unit 1 according to the first or second aspect, in which the elastic portions 7 have an elastic force smaller than a biasing force of the biasing member 5.

According to a fourth aspect of the present disclosure, there is provided the inspection unit 1 according to any one of the first to third aspects, in which when a tip portion 6a of each of the probe pins 6 is located at a protruded position that protrudes outside from an opening 3a provided in the socket 3, the elastic portions 7 are in an elastically non-deformed state, and when the tip portion 6a of each of the probe pins 6 moves to a housed position that is located inside the socket 3, the elastic portions 7 elastically deform.

According to a fifth aspect of the present disclosure, there is provided the inspection unit 1 according to the fourth aspect, in which the probe pins 6 are each a plate-shaped probe pin, and are stacked in a thickness direction Z, and
the elastic portions 7 each include elastic arm portions 71 and 72 protruding, from both side portions of each of the probe pins 6, in a width direction Y orthogonal to the axial direction X and the thickness direction Z.

According to a sixth aspect of the present disclosure, there is provided the inspection unit according to the fourth aspect, in which the probe pins 6 are each a plate-shaped probe pin, are stacked in a thickness direction Z, and are sandwiched by a sandwiching member 8 having elasticity in the thickness direction Z.

According to a seventh aspect of the present disclosure, there is provided the inspection unit 1 according to the sixth aspect, in which at least one of the plurality of probe pins 6 has an elongated hole 6c that penetrates in the thickness direction Z and is longer in the axial direction X, and the sandwiching member 8 includes a pin 85 inserted in the elongated hole 6c.

According to an eighth aspect of the present disclosure, there is provided the inspection unit 1 according to the fourth aspect, in which the probe pins 6 are each a plate-shaped probe pin and are stacked in a thickness direction, and
the biasing member 5 includes:
a first spring member 51 that biases one end portion side of each of the probe pins 6 in a width direction Y orthogonal to the axial direction X and a thickness direction Z; and
a second spring member 52 that biases another end portion side of each of the probe pins 6 in the width direction Y.

According to a ninth aspect of the present disclosure, there is provided the inspection unit 1 according to the first aspect, in which the probe pins 6 are each a plate-shaped probe pin and are stacked in a thickness direction Z, and
one of the probe pins 6 adjacent to each other is provided with an elastic piece 6d that biases another one of the probe pins 6 adjacent to each other in the thickness direction Z.

According to a tenth aspect of the present disclosure, there is provided an inspection device 200 including the inspection unit 1 or 1A according to any one of a plurality of the first to ninth aspects.

When arbitrary embodiments or variations among the above-described various embodiments or variations are appropriately combined, their respective effects can be exhibited. In addition, it is possible to combine the embodiments, to combine practical examples, and to combine the embodiment and the practical examples, and at the same time, it is possible to combine features in different embodiment or practical examples.

Although the present disclosure has been fully described in relation to preferred embodiments with reference to the accompanying drawings, various variations and modifications will be apparent to those skilled in the art. It should be understood that such variations and modifications are within the scope of the present disclosure unless the variations and the modifications depart from the scope of the present disclosure as set forth in the appended claims.

Since the inspection unit and the inspection device of the present disclosure can improve the contact reliability between the electrode terminal of the battery and the probe pin, the inspection unit and the inspection device are particularly useful as an inspection unit and an inspection device used for inspecting a prismatic battery for an EV.

1. An inspection unit that comes into contact with an electrode terminal of a battery to inspect performance of the battery, the inspection unit comprising:
a plurality of probe pins;
a socket that houses the plurality of probe pins to be movable by a first distance in an axial direction;
a housing that houses the socket to be movable by a second distance in the axial direction;
a biasing member that is disposed inside the housing and biases the socket in the axial direction such that a part of the socket protrudes outside from an opening provided in the housing; and
elastic portions that are disposed inside the socket and each elastically deform so as to move one of the probe pins independently in the axial direction.

2. The inspection unit according to claim 1, wherein the first distance is shorter than the second distance.

3. The inspection unit according to claim 1, wherein the elastic portions have an elastic force smaller than a biasing force of the biasing member.

4. The inspection unit according to claim 1, wherein when a tip portion of each of the probe pins is located at a protruded position that protrudes outside from an opening provided in the socket, the elastic portions are in an elastically non-deformed state, and when the tip portion of each of the probe pins moves to a housed position that is located inside the socket, the elastic portions elastically deform.

5. The inspection unit according to claim 4, wherein the probe pins are each a plate-shaped probe pin, and are stacked in a thickness direction, and
the elastic portions each include elastic arm portions protruding, from both side portions of each of the probe pins, in a width direction orthogonal to the axial direction and the thickness direction.

6. The inspection unit according to claim 4, wherein the probe pins are each a plate-shaped probe pin, are stacked in a thickness direction, and are sandwiched by a sandwiching member having elasticity in the thickness direction.

7. The inspection unit according to claim 6, wherein at least one of the plurality of probe pins has an elongated hole that penetrates in the thickness direction and is longer in the axial direction, and
the sandwiching member includes a pin inserted in the elongated hole.

8. The inspection unit according to claim 4, wherein the probe pins are each a plate-shaped probe pin and are stacked in a thickness direction, and
the biasing member includes:
a first spring member that biases one end portion side of each of the probe pins in a width direction orthogonal to the axial direction and a thickness direction; and
a second spring member that biases another end portion side of each of the probe pins in the width direction.

9. The inspection unit according to claim 1, wherein the probe pins are each a plate-shaped probe pin and are stacked in a thickness direction, and
one of the probe pins adjacent to each other is provided with an elastic piece that biases another one of the probe pins adjacent to each other in the thickness direction.

10. An inspection device comprising a plurality of the inspection units according to claim 1.
